(19) United States
(12) Patent Application Publication
(10) Pub. No.: US 2026/0316523 A1
(43) Pub. Date: Oct. 15, 2026

(54) SYSTEMS AND METHODS FOR LOAD MANAGEMENT IN A VEHICLE

(71) Applicant: Ford Global Technologies, LLC, Dearborn, MI (US)

(72) Inventors: Stuart C. Salter, White Lake, MI (US); Mark J. Ferrel, Sunset Beach, NC (US); Belinda J. Cleveland, Southfield, MI (US); Todd Ansbacher, Westland, MI (US); David Celinske, Wolverine Lake, MI (US)

(73) Assignee: Ford Global Technologies, LLC, Dearborn, MI (US)

(21) Appl. No.: 19/175,109

(22) Filed: Apr. 10, 2025

(51) Int. Cl. B60H 1/32; B60L 1/00; B60L 15/20; B60L 58/12

(52) U.S. Cl. CPC B60H 1/3208; B60L 1/003; B60L 15/20; B60L 58/12; B60H 2001/3292

(57) ABSTRACT

A vehicle including a battery and a processor is disclosed. The battery may power a vehicle powertrain and a vehicle refrigerator. The processor may determine a vehicle route on a trip and estimate a geographical area in the vehicle route in which the vehicle powertrain is expected to require a higher proportion of available power from the battery. The processor may further precool the vehicle refrigerator by using available power from the battery to a first temperature from a second temperature, at a predefined time before the vehicle reaches the geographical area. The processor may further cause the battery to provide a lower proportion of available power to the vehicle refrigerator and the higher proportion to the vehicle powertrain when the vehicle travels in the geographical area.

### FIELD

The present disclosure relates to vehicles and more particularly to systems and methods for load management in a vehicle.

### BACKGROUND

Modern vehicles have power systems to power auxiliary accessories such as a compressor, a lifting equipment, a vehicle refrigerator, etc. For example, some modern vehicles have power take-off (PTO), electric PTO (ePTO), etc. that facilitates powering of auxiliary accessories.

An ePTO decouples auxiliary functions, such as powering accessories, from vehicle engine usage. Stated another way, an ePTO enables a vehicle operator to power accessories even when the vehicle engine may not be operational. An ePTO may include an inverter and an electric motor powered by a DC power source, such as a battery, which may be used to power the accessories.

In electric and hybrid vehicles, the battery (e.g., 800V battery) supplies power to a powertrain for vehicle propulsion and to the ePTO for powering the auxiliary accessories such as a vehicle refrigerator. The battery has a predefined maximum power capacity, so it can only provide a certain amount of energy at a time, which is to be divided between the vehicle propulsion and the ePTO.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle with a vehicle refrigerator in accordance with the present disclosure.

FIG. 2 depicts a block diagram of an example system to facilitate load management in a vehicle in accordance with the present disclosure.

FIG. 3 depicts an example view of a vehicle moving in an uphill section in accordance with the present disclosure.

FIG. 4 depicts a flow diagram of an example method to manage load in a vehicle in accordance with the present disclosure.

### DETAILED DESCRIPTION

### Overview

The present disclosure describes a system and method to manage load between a vehicle powertrain and an electric power take-off (ePTO) in an electric vehicle or a hybrid vehicle. The electric vehicle may include a high-voltage battery that may provide power to the vehicle powertrain and the ePTO. The vehicle powertrain may generate and deliver power to move the vehicle. Specifically, the vehicle powertrain may convert electrical energy from the battery into mechanical motion, which enables vehicle movement. The ePTO may transfer power from the battery to an auxiliary accessory (e.g., a vehicle refrigerator) to enable the accessory's operation.

The system may divide the battery energy/power between the vehicle powertrain and the ePTO based a plurality of factors/parameters including, but not limited to, power availability and/or state of charge (SoC) associated with the battery, driving conditions (e.g., whether the vehicle is moving in an uphill or a downhill section, etc.), accessory requirements (e.g., maintaining temperature in the vehicle refrigerator within a predefined range), and/or the like.

The system may predict a priority of battery power usage between the vehicle powertrain and the ePTO, and may assign available power from the battery to the vehicle powertrain and the ePTO based on the predicted priority. In some aspects, the system may predict/estimate when the vehicle propulsion may take priority over the vehicle refrigeration usage (i.e., when the vehicle powertrain may require more battery power), and may control the temperature associated with the vehicle refrigeration based on the prediction, so that the items stored in a vehicle refrigeration compartment may not get spoiled. In an exemplary aspect, the system may precool the vehicle refrigerator in advance, before a time duration when the vehicle propulsion takes priority over the vehicle refrigerator usage. During the time duration in which the vehicle propulsion takes priority over the vehicle refrigerator usage, the system may turn-off or reduce a speed of a vehicle refrigerator compressor, to enable the vehicle powertrain to consume more available power from the battery. For example, the system may cause the battery to provide a higher proportion of available power from the battery to the vehicle powertrain and a lower proportion of available power from the battery to the ePTO (and hence to the vehicle refrigerator) when the vehicle propulsion (or providing power to the vehicle powertrain) is priority. An example of such a situation would be when the vehicle is traveling on an uphill road section. In this situation, the vehicle powertrain may require more battery power to enable the vehicle to efficiently cover the uphill journey.

In some aspects, the system may estimate when and where the vehicle propulsion may take priority over the vehicle refrigerator usage, and may precool the vehicle refrigerator based on the estimation. To perform such estimation, the system may determine a route in which the vehicle is expected to travel. Responsive to the route determination, the system may estimate one or more geographical area(s)/spot(s) in the vehicle route in which the vehicle powertrain may require more available power (or higher proportion of available power) from the battery, to travel through such geographical area(s). For example, when the vehicle travels in an uphill section, the vehicle powertrain may require additional battery power than the usual battery power required for traveling on a flat road. In some aspects, the system may determine/estimate such uphill sections (or such geographical spots) in the vehicle route in which the vehicle powertrain may require more power to travel.

Responsive to estimating such geographical area(s), the system may precool the vehicle refrigerator by using available power from the battery to a first temperature from a second temperature via the ePTO, at a predefined time before the vehicle reaches the geographical area. In this case, the first temperature may be less than the second temperature. When the vehicle travels in the geographical area, the system may reduce speed (or turn-off) the vehicle refrigerator compressor to cause the battery to provide a lower proportion of available power (or no power) to the vehicle refrigerator and the higher proportion to the vehicle powertrain. Since the vehicle refrigerator is already precooled before the vehicle reaches the geographical area, the items stored in the vehicle refrigerator may not get spoiled even if lesser proportion energy is provided to the vehicle refrigerator (and hence there may be less cooling) when the vehicle travels through the geographical area.

In some aspects, the system may estimate an arrival time at which the vehicle is expected to reach the geographical area (e.g., the uphill section). Responsive to the estimation of the arrival time, the system may commence precooling the vehicle refrigerator at the predefined time before the arrival time duration, via the ePTO.

In further aspects, responsive to the route determination for the vehicle, the system may predict that the vehicle may travel through hot weather area(s) in the route. Based on such prediction, the system may precool the vehicle refrigerator in advance (e.g., before the vehicle starts to travel in such hot area(s)). In another aspect, the system may precool the vehicle refrigerator when the battery may be in charging state (to get ahead of situations in which the vehicle powertrain requires the higher proportion of available power from the battery). In yet another aspect, the system may increase the cooling in the vehicle refrigerator when the vehicle may be moving in a downhill section or when the vehicle is coasting. In some aspects, the system may precool the vehicle refrigerator via regenerative vehicle speed reduction when the vehicle may be moving in a downhill section.

The present disclosure discloses a system and method to facilitate managing load between vehicle propulsion and a vehicle refrigerator. The system manages the load such that the ePTO can provide at least some cooling to the vehicle refrigerator compartment when the vehicle propulsion is the priority, so that the items placed inside the vehicle refrigerator remain in a cool environment (and may not get spoiled).

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

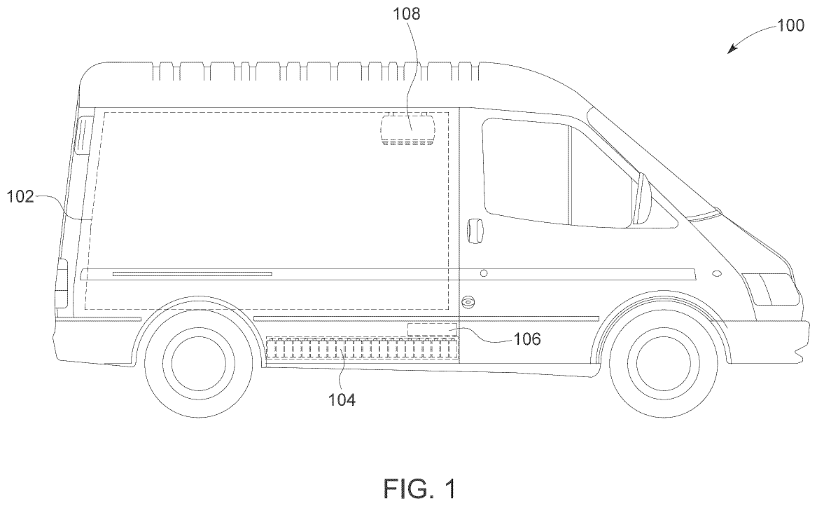

FIG. 1 depicts an example vehicle 100 with a vehicle refrigerator 102 in accordance with the present disclosure. The vehicle 100 may be a battery electric vehicle (BEV). The vehicle 100 may take the form of any passenger or commercial vehicle such as an off-road vehicle, a car, a crossover vehicle, a van, a minivan, a bus, a truck, etc. Further, the vehicle 100 may be a manually driven vehicle and/or may be configured to operate in partially or fully autonomous mode. In further aspects, the vehicle 100 may be a plug-in hybrid electric vehicle (PHEV). When the vehicle 100 is PHEV, the vehicle 100 may be equipped with an internal combustion engine that can be employed either alone or in combination with other energy sources to propel the vehicle 100.

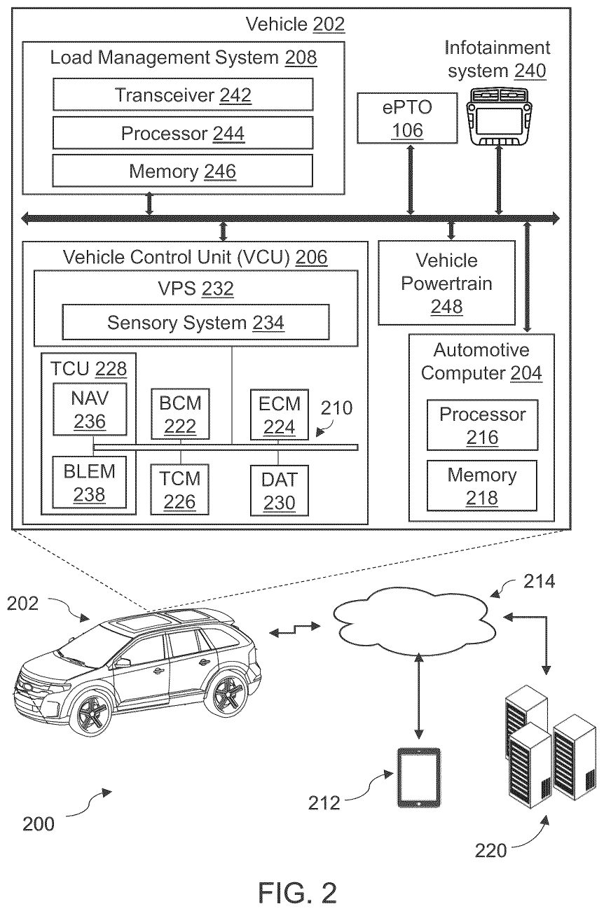

The vehicle 100 may include a high-voltage battery 104 (hereinafter referred to as battery 104) that may provide power to a vehicle powertrain/drivetrain (shown as vehicle powertrain 248 in FIG. 2) used for vehicle propulsion, and to one or more auxiliary accessories. The vehicle powertrain may generate and deliver power to move the vehicle 100. Specifically, the vehicle powertrain may convert electrical energy from the battery 104 into mechanical motion, which may enable the vehicle movement. The vehicle 100 may further include a vehicle power system (e.g., an electric Power Takeoff (ePTO) 106) that may receive power from the battery 104 and provide/supply power to the auxiliary accessory, to enables the accessory's operation. In an exemplary aspect, the auxiliary accessory may be the vehicle refrigerator 102. In other aspects, the auxiliary accessory may include, for example, a compressor, a lifting equipment, a lighting equipment, a fluid transfer pump, and/or the like. In an exemplary aspect, the ePTO 106 may include an inverter and an electric motor (not shown) that may be powered by the battery 104.

The vehicle 100 may further include a load management system (shown as load management system 208 in FIG. 2) that may manage/balance load between the vehicle powertrain/drivetrain (used for vehicle propulsion) and the ePTO 106. In some aspects, the system may monitor the amount of battery power that the ePTO 106 may be consuming to power the auxiliary accessory and cause adjustment of the battery output to maintain a balance of battery usage between the vehicle powertrain and the ePTO 106 (e.g., by turning on/off the auxiliary accessory). The system may divide/balance the battery energy usage between the vehicle powertrain and the ePTO 106 based a plurality of factors/parameters including, but not limited to, power availability and/or a state of charge (SoC) associated with the battery 104, driving conditions (e.g., whether the vehicle 100 is moving in an uphill or a downhill section, etc.), accessory requirements (e.g., maintaining temperature in the vehicle refrigerator 102), and/or the like.

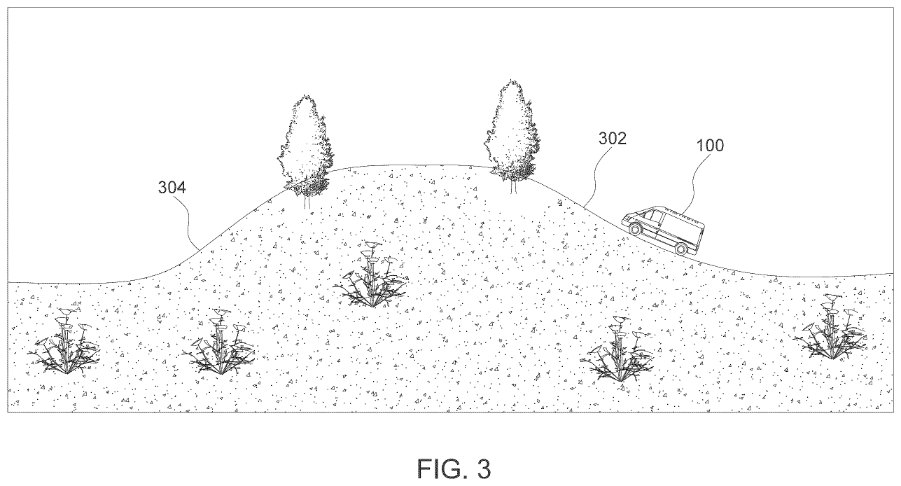

In some aspects, the system may determine a priority of power usage between the vehicle powertrain and the ePTO 106, and cause adjustment of the battery output (or available power from the battery 104) to the ePTO 106 based on the priority. For instance, when the vehicle 100 is traveling in an uphill road section (as shown in FIG. 3), the system may prioritize the power usage for the vehicle powertrain over the ePTO 106 (as the vehicle powertrain requires more power to travel on the uphill section). Based on such prioritization, the system may control a vehicle refrigerator compressor 108 associated with the vehicle refrigerator 102 so that more available power may be provided to the vehicle powertrain when the vehicle 100 travels on the uphill section, while still keeping the vehicle refrigeration compartment in a predefined temperature range (e.g., between 36 °F and 46 °F). In some aspects, the system may operate the vehicle refrigerator compressor 108 at a reduced speed when the vehicle 100 travels on the uphill section, so that the vehicle refrigerator 102 consumes less power and the battery 104 provides more power to the vehicle powertrain.

In some aspects, the system may predict that the vehicle 100 may travel in the uphill section (e.g., based on a route information associated with a route the vehicle 100 may be traveling), and may control the vehicle refrigerator 102 based on the prediction. In some aspects, the system may precool the vehicle refrigerator 102 in advance (e.g., before the vehicle 100 starts to travel on the uphill section), via the ePTO 106, so that the vehicle refrigerator 102 has enough cooling before the vehicle 100 starts to travel on the uphill section. In some aspects, the system may precool the vehicle refrigerator 102 within the acceptable temperature range. For example, the system may precool the vehicle refrigerator 102 to a first temperature (e.g., 36 °F) from a second temperature (e.g., 46 °F). Stated another way, the system may reduce the temperature of the vehicle refrigerator 102 before the acceptable minimum temperature, before the vehicle 100 starts to travel on the uphill section.

The system may further turn-off or reduce a speed of the vehicle refrigerator compressor 108 when the vehicle 100 starts to travel on the uphill section, which enables the vehicle powertrain to consume more available power from the battery 104 to travel on the uphill section, as mentioned above. The system may reduce the compressor speed so that the ePTO 106 can provide at least some cooling in the vehicle refrigerator compartment during the vehicle's uphill travel. In this manner, when the vehicle powertrain takes the priority over the ePTO 106, the system may control the energy usage of the vehicle refrigerator 102 in advance, so that the items placed inside the vehicle refrigerator 102 remain in the cool environment (and do not get spoiled) when the system turns-off or reduces the speed of the vehicle refrigerator compressor 108.

In addition or alternative to predicting when the vehicle 100 may travel on an uphill road section, the system may predict that the vehicle 100 may travel through hot weather area(s) in the route (e.g., based on the route information). Based on such prediction, the system may precool the vehicle refrigerator 102 in advance, e.g., before the vehicle 100 starts to travel in the hot area(s). In further aspects, the system may precool the vehicle refrigerator 102 when the battery 104 may be in charging state, e.g., to get ahead of situations in which the vehicle powertrain requires the higher proportion of available power from the battery 104.

In further aspects, the system may increase the cooling in the vehicle refrigerator 102 when the vehicle 100 may be moving in downhill road sections or when the vehicle 100 may be coasting. In some aspects, the system may precool the vehicle refrigerator 102 via regenerative vehicle speed reduction when the vehicle 100 is moving in downhill road sections.

Functions vehicle details are described below in conjunction with FIG. 2.

The vehicle 100 may implement and/or perform operations, as described here in the present disclosure, in accordance with the owner manual and safety guidelines. In addition, any action taken by the vehicle operator based on the notifications provided by the vehicle 100 should comply with all the rules specific to the location and operation of the vehicle 100 (e.g., Federal, state, country, city, etc.). The notifications, as provided by the vehicle 100, should be treated as suggestions and only followed according to any rules specific to the location and operation of the vehicle 100.

FIG. 2 depicts a block diagram of an example system 200 to facilitate load management in a vehicle in accordance with the present disclosure. While describing FIG. 2, references may be made to FIG. 3.

The system 200 may include a vehicle 202, which may be the same as the vehicle 100. The vehicle 202 may include an automotive computer 204, a Vehicle Control Unit (VCU) 206, and a load management system 208 (same as the load management system described above in conjunction with FIG. 1). The VCU 206 may include a plurality of Electronic Control Units (ECUs) 210 disposed in communication with the automotive computer 204.

The system 200 may further include a mobile device 212 or a user device 212 that may connect with the automotive computer 204 and/or the load management system 208 by using wired and/or wireless communication protocols and transceivers. In some aspects, the mobile device 212 may be associated with the vehicle operator, a fleet manager or a vehicle owner. The mobile device 212 may be, for example, a tablet, a laptop, a smart watch, or any other device with communication capabilities. The mobile device 212 may communicatively couple with the vehicle 202 via one or more network(s) 214.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or the load management system 208 may be installed anywhere in the vehicle 202. Further, the automotive computer 204 may operate as a functional part of the load management system 208. The automotive computer 204 may be or include an electronic vehicle controller, having one or more processor(s) 216 and a memory 218. Moreover, the load management system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a vehicle load management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the load management system 208 may be disposed in communication with one or more server(s) 220 and the mobile device 212 via the network 214. In some aspects, the server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In further aspects, the server 220 may store historical information associated with the vehicle 202, such as vehicle historical travel patterns that indicate the routes on which the vehicle 202 typically travels. In addition, the server 220 may store route information that may be associated with one or more routes on which the vehicle 202 may travel. The route information may include, for example, road slope information, weather condition information, traffic information, and/or the like. The road slope information may include information associated with how steep a road is (or a slope percentage), a grade of the road, and/or the like. The weather condition information may include temperature information (e.g., hot or cold weather information). The traffic information may include traffic congestion information, real-time traffic speed, and/or the like.

In accordance with some aspects, the VCU 206 may share a power bus with the automotive computer 204 and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234.

The vehicle sensory system 234 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, weight sensors, vehicle wheel sensors, vehicle internal or external cameras, vehicle external power usage sensors, etc. In some aspects, the vehicle external power usage sensors may be configured to detect ePTO usage, such as an amount of energy drawn, a time duration for which the energy is drawn, a rate at which the energy is drawn, etc. In addition, the vehicle sensory system 234 may monitor real-time available power that can be provided from the battery 104, a state of charge (SOC) level of the battery 104, etc.

In some aspects, the VCU 206 may control vehicle 202 operational aspects and implement one or more instruction sets received from the mobile device 212, from one or more instruction sets stored in the computer memory 218, including instructions operational as part of the load management system 208.

The TCU 228 may be configured and/or programmed to provide vehicle connectivity to wireless computing systems onboard and off board the vehicle 202, and may include a Navigation (NAV) receiver 236 for receiving and processing a GPS signal, a BLE®Module (BLEM) 238, a Wi-Fi transceiver, a UWB transceiver, and/or other wireless transceivers (not shown in FIG. 2) that may be configurable for wireless communication (including cellular communication) between the vehicle 202 and other systems (e.g., a vehicle key fob, not shown in FIG. 2), computers, and modules. The TCU 228 may be disposed in communication with the ECUs 210 by way of a bus.

The ECUs 210 may control aspects of vehicle operation and communication using inputs from human drivers, inputs from an autonomous vehicle controller, the load management system 208, and/or via wireless signal inputs received via the wireless connection(s) from other connected devices, such as the mobile device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, door locks and access control (including ePTO control), vehicle refrigerator control, and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, and/or adaptive cruise control, among other features. The DAT controller 230 may also provide aspects of user and environmental inputs usable for user authentication.

In some aspects, the automotive computer 204 may connect with an infotainment system 240 that may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive vehicle operator instructions via the touchscreen interface portion, and/or display notifications, navigation maps, etc. on the touchscreen interface portion.

The computing system architecture of the automotive computer 204, the VCU 206, and/or the load management system 208 may omit certain computing modules. It should be readily understood that the computing environment depicted in FIG. 2 is an example of a possible implementation according to the present disclosure, and thus, it should not be considered limiting or exclusive.

The vehicle 202 may further include the battery 104 configured to store energy and provide power to the vehicle powertrain 248 for vehicle propulsion and to the auxiliary accessories (including the vehicle refrigerator 102). The vehicle 202 may additionally include the ePTO 106 that may transfer power from the battery 104 to the auxiliary accessory. The auxiliary accessory may be, for example, the vehicle refrigerator 102 described above in conjunction with FIG. 1. In some aspects, the ePTO 106 may include an inverter and an electric motor (not shown) that may be powered by the battery 104.

In accordance with some aspects, the load management system 208 may be integrated with and/or executed as part of the ECUs 210. The load management system 208, regardless of whether it is integrated with the automotive computer 204 or the ECUs 210, or whether it operates as an independent computing system in the vehicle 202, may include a transceiver 242, a processor 244 and a computer-readable memory 246.

The transceiver 242 may receive information/inputs from one or more external devices or systems, e.g., the mobile device 212, the server(s) 220, and/or the like via the network 214. For example, the transceiver 242 may obtain inputs associated with a vehicle route (e.g., a start location and a destination location) from the mobile device 212. Further, the transceiver 242 may transmit notifications (e.g., alert/alarm signals) or information to the external devices or systems. In addition, the transceiver 242 may receive information/inputs from vehicle 202 components such as the infotainment system 240, the vehicle sensory system 234, and/or the like. Further, the transceiver 242 may transmit instructions/command signals to the vehicle refrigerator compressor 108 (or other auxiliary accessories) to manage/balance the load, and/or to other vehicle components.

The processor 244 and the memory 246 may be the same as or similar to the processor 216 and the memory 218, respectively. Specifically, the processor 244 may utilize the memory 246 to store programs in code and/or to store data for performing aspects in accordance with the disclosure. The memory 246 may be a non-transitory computer-readable memory storing the vehicle load management program code. In addition, the memory 246 may store details associated with power consumption rate and/or capacity (or expected power consumption rate) of different accessories that may be connected with the ePTO 106 to draw power. In further aspects, the memory 246 may store the vehicle historical travel patterns, which the vehicle 202 may obtain from the server 220.

In operation, when the vehicle 202 needs to complete a trip and keep the items (e.g., medical supplies/groceries/etc.) placed in the vehicle refrigeration compartment within a predefined temperature range (e.g., between 36 °F and 46 °F), the processor 244 may manage the load or the supply of battery power between the vehicle powertrain 248 and the vehicle refrigerator 102 so that the vehicle 202 may complete the trip while keeping the vehicle refrigeration compartment within the predefined temperature range. For example, the processor 244 may cause the battery 104 to provide a higher proportion of available battery power to the vehicle powertrain 248 and a lower proportion of available power to the vehicle refrigerator 102 when the vehicle propulsion is priority, while keeping the vehicle refrigeration compartment within the predefined temperature range so that the vehicle 202 can successfully complete the trip.

The processor 244 may first determine the vehicle route that the vehicle 202 may take on the trip. In some aspects, processor 244 may determine the vehicle route based on user inputs. In this case, the transceiver 242 may receive inputs from the vehicle operator via the mobile device 212 or the infotainment system 240. The inputs may be indicative of the vehicle route (e.g., include a start location and a destination location) that the vehicle 202 may take. The processor 244 may obtain the inputs and determine the vehicle route based on the obtained inputs. For example, when the vehicle operator provides the start location and the destination location of the trip, the processor 244 may estimate or determine the vehicle route from the start location to the destination location (e.g., based on map information that may pre-stored in the memory 246 or obtained from the server 220).

In further aspects, the processor 244 may determine the vehicle route based on historical travel pattern. In this case, the processor 244 may obtain the vehicle's historical travel pattern from the server 220 or the memory 246, and determine the vehicle route based on the vehicle historical travel patterns. For example, the processor 244 may determine that the vehicle 202 generally moves from a first location to a second location during morning hours (e.g., between 7 AM to 10 AM). Based on such determination, the processor 244 may estimate/determine the vehicle route that the vehicle 202 may take.

Responsive to determining the vehicle route, the processor 244 may estimate one or more geographical area(s)/spot(s) in the vehicle route in which the vehicle powertrain 248 may require more power (or a higher proportion of available power) from the battery 104, to travel through such geographical area(s). For example, when the vehicle 202 is expected to travel on an uphill section 302 (as shown in FIG. 2) on the vehicle route, the vehicle powertrain 248 may require more power than the usual power required for traveling on a flat road. In some aspects, the processor 244 may determine such uphill sections 302 (or such geographical spots) in the vehicle route in which the vehicle powertrain 248 may require more power to travel.

To estimate these geographical areas, the processor 244 may obtain route information associated with the vehicle route on which the vehicle 202 may travel, from the server 220 (e.g., via the transceiver 242). As described above, the route information may include, for example, the road slope information, the weather condition information, the traffic information, and/or the like. Responsive to obtaining the route information, the processor 244 may estimate the geographical area(s) described above on the vehicle route based on the route information. For example, the processor 244 may determine if there are any uphill sections in the vehicle route based on the route information.

When the processor 244 determines the presence of uphill section(s) 302 in the vehicle route, the processor 244 may determine the details of the uphill section(s) 302 such as road slope/grade, a length of the uphill section 302, traffic information associated with the uphill section 302, etc., based on the route information. Based on the determination of such details of the uphill section(s) 302, the processor 244 may estimate the power required by the vehicle powertrain 248 to move the vehicle 202 in the uphill section(s) 302. Stated another way, the processor 244 may estimate the higher proportion of power required by the vehicle powertrain 248 to move the vehicle 202 through the geographical area (e.g., the uphill section(s) 302). In some aspects, the higher proportion of power, as described herein, may be greater than a predefined threshold value. In an exemplary aspect, the predefined threshold value may be equivalent to 50%, 60%, 70%, or the like, of the available power or maximum capacity of the battery 104. In some aspects, the predefined threshold value may be based on the usual or typical power required by the vehicle powertrain 248 to travel on a flat road.

The processor may further obtain vehicle information from the vehicle sensory system 234. The vehicle information may include, for example, the real-time available power that may be provided from the battery 104, the SOC level of the battery 104, the amount of energy drawn by the ePTO 106, a real-time time duration for which the ePTO 106 may be drawing the energy, a real-time rate at which the ePTO 106 may be drawing the energy, etc. Based on the estimated power required by the vehicle powertrain 248 to move the vehicle 202 in the uphill section(s) 302 and the current vehicle information (including the real-time available power, the energy usage by the ePTO 106, etc.), the processor 244 may control the operation of the vehicle refrigerator 102 (e.g., the vehicle refrigerator compressor 108) and cause the battery 104 to provide more or less proportion of battery power to the ePTO 106. In some aspects, based on the estimated power (or the higher proportion of power described above) required by the vehicle powertrain 248 to move the vehicle 202 on the uphill section(s) 302, the processor 244 may estimate the power (or a “lower proportion of power”) that may be fed to the vehicle refrigerator 102 for its operation. This lower proportion of power may be the difference between the available power or maximum capacity of the battery 104 and the higher proportion of power described above. Based on the estimation of the higher and lower proportions of power as described above, the processor 244 may cause the battery 104 to provide the lower proportion of power to the vehicle refrigerator 102 and the higher proportion of power to the vehicle powertrain 248 when the vehicle 202 travels in the geographical area.

In some aspects, to enable the vehicle powertrain 248 to use more available battery power (or a higher proportion of available power from the battery 104) to move through the identified geographical area(s) described above, the processor 244 may precool the vehicle refrigerator 102 by using available power from the battery 104 to a lower temperature (e.g., to the first temperature from the second temperature). To precool the vehicle refrigerator 102, the processor 244 may control the vehicle refrigerator compressor 108 (e.g., increase the speed of the vehicle refrigerator compressor 108) such that the vehicle refrigerator 102 may cool to the first temperature. In some aspects, the processor 244 may precool the vehicle refrigerator 102 at a predefined time before the vehicle 202 is expected to reach the geographical area. Thereafter, when the vehicle 202 travels through the geographical area (or when the vehicle 202 reaches the geographical area, e.g., the uphill section 302), the processor 244 may cause the battery 104 to provide a lower proportion of available power to the vehicle refrigerator 102 and the higher proportion to the vehicle powertrain 248, to enable the vehicle powertrain 248 to efficiency move the vehicle 202 through the uphill section 302. Precooling the vehicle refrigerator 102 before the vehicle 202 reaches the uphill section 302 ensures that even if the vehicle refrigerator 102 obtains a lesser amount of battery energy when the vehicle is traveling through the uphill section 302, the temperature in the refrigerant compartment does not drop below the minimum acceptable level, thereby preventing the items stored in the vehicle refrigerator 102 from getting spoiled.

As described above, the processor 244 may precool the vehicle refrigerator 102 in advance (e.g., before the vehicle 202 starts to travel on the uphill section 302) and may provide less power (or no power) to the vehicle refrigerator 102 or the vehicle refrigerator compressor 108 when the vehicle 202 travels on the uphill section 302. In some aspects, the processor 244 may turn-off or reduce a speed of the vehicle refrigerator compressor 108 when the vehicle 202 starts to travel on the uphill section 302, which causes the vehicle refrigerator 102 to draw less power from the battery 104 and thus enables the vehicle powertrain 248 to consume more available power from the battery 104 to efficiently travel on the uphill section 302. The processor 244 may reduce the compressor speed so that the ePTO 106 can provide at least some cooling in the vehicle refrigerator compartment when the vehicle 202 travels through the uphill section 302, so that the items placed inside the vehicle refrigerator 102 may remain in the cool environment (and do not get spoiled).

In some aspects, to perform the operation described above, the processor 244 may first estimate an arrival time at which the vehicle 202 is expected to reach the geographical area (e.g., the uphill section 302) and a time duration for which the vehicle 202 may travel in the geographical area. The processor 244 may estimate the arrival time based on the route information. For example, the processor 244 may determine that the vehicle 202 may reach the uphill section 302 at around 9 AM based on the traffic conditions on the route and the location of the uphill section 302. Responsive to estimating the arrival time, the processor 244 may precool the vehicle refrigerator 102 at the predefined time (e.g., 30 minutes) before the estimated arrival time, via the ePTO 106. For example, the processor 244 may start precooling the vehicle refrigerator 102 at 8:30 AM.

Therefore, when the vehicle 202 reaches the uphill section 302 at 9 AM, the processor 244 may reduce the speed of the vehicle refrigerator compressor 108 for 15 minutes or till the vehicle 202 is traveling on the uphill section 302, to enable the vehicle powertrain 248 to use the higher proportion of the available battery power to efficiency move through the uphill section 302. In some aspects, the processor 244 may reduce the speed of the vehicle refrigerator compressor 108 when the vehicle powertrain 248 starts to draw more battery power and the available battery power for the ePTO 106 (and hence for the vehicle refrigerator 102) reduces.

In further aspects, the processor 244 may monitor the vehicle travel and may determine that the vehicle 202 may have started to move on a downhill section 304 (shown in FIG. 3) based on the inputs obtained from the vehicle sensory system 234. Responsive to such determination, the processor 244 may increase the cooling of the vehicle refrigerator 102 when the vehicle 202 moves on the downhill section 304, via the ePTO 106. In this case, the processor 244 may increase the speed of the vehicle refrigerator compressor 108 when the vehicle 202 moves in the downhill section 304, to increase the refrigerant cooling.

In addition or alternative to predicting that the vehicle 202 may travel on the uphill and/or downhill sections 302, 304, the processor 244 may predict hot weather section(s) in the vehicle route and may precool the vehicle refrigerator 102 based on the prediction of the hot weather sections in the vehicle route, via the ePTO 106. The processor 244 may predict hot weather sections in the vehicle route based on the route information (similar to predicting the geographical area/uphill section 302 described above). The processor 244 may estimate an arrival time at which the vehicle 202 is expected to reach at the hot weather section(s) in the vehicle route, and may precool the vehicle refrigerator 102 before the vehicle 202 reaches the hot weather section(s).

In further aspects, the processor 244 may determine that the battery 104 is in a charging state, and may precool the vehicle refrigerator 102 responsive to a determination that the battery 104 is in the charging state, via the ePTO 106 (e.g., to get ahead of situations in which the vehicle powertrain 248 requires the higher proportion of available power from the battery 104). In some aspects, the processor 244 may predict/estimate the vehicle route for the next day and estimate the driving conditions (presence of uphill section 302, the hot temperature section, etc.) and the accessory requirement (required temperature in the vehicle refrigeration compartment), and may precool the vehicle refrigerator 102 during the battery's charging state based on such estimation.

In further aspects, the processor 244 may cause the vehicle speed to reduce or the vehicle 202 to slow down before the vehicle 202 reaches the geographical area (e.g., the uphill section 302) to enable efficient precooling of the vehicle refrigerator 102. For example, when cooling the vehicle refrigerator 102 is a priority, the processor 244 may cause the vehicle 202 to slow down (and hence cause the vehicle powertrain 248 to draw less battery battery) so that the vehicle refrigeration compartment may be cooled before the vehicle 202 reaches the geographical area (e.g., the uphill section 302). In further aspects, the processor 244 may control the operation of other auxiliary accessories getting powered via the ePTO 106 to cool or maintain temperature of the vehicle refrigeration compartment.

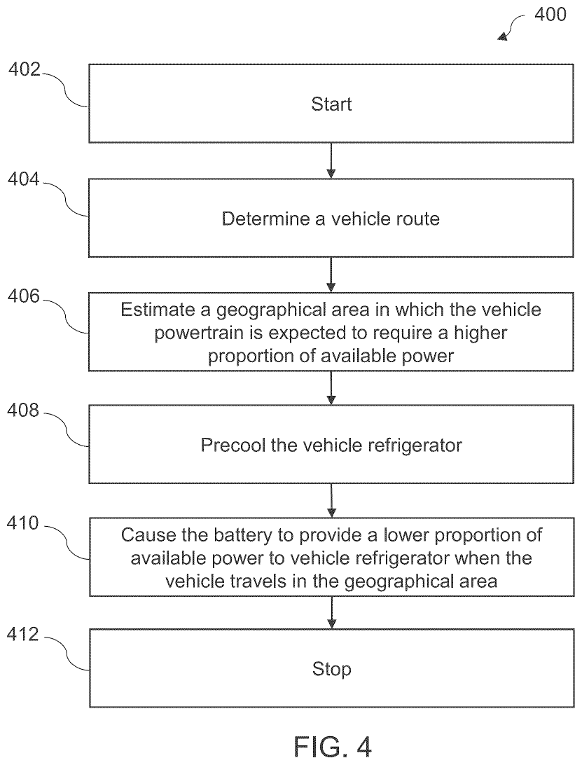

FIG. 4 depicts a flow diagram of an example method 400 to manage load in a vehicle, in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 500 may include determining, by the processor 244, a vehicle route on a trip. At step 406, the method 400 may include estimating, by the processor 244, a geographical area in the vehicle route in which the vehicle powertrain 248 is expected to require a higher proportion of available power from the battery 104. At step 408, the method 400 may include precooling, by the processor 244, the vehicle refrigerator 102 by using the available power from the battery 104 to the first temperature from the second temperature, at a predefined time before the vehicle 100 reaches the geographical area. At step 412, the method 400 may include causing, by the processor 244, the battery 104 to provide a lower proportion of available power to the vehicle refrigerator 102 and the higher proportion of battery power to the vehicle powertrain 248 when the vehicle 100 travels in the geographical area.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a battery configured to power a vehicle powertrain and a vehicle refrigerator; and
a processor configured to:
determine a vehicle route on a trip;
estimate a geographical area in the vehicle route in which the vehicle powertrain is expected to require a higher proportion of available power from the battery;
precool the vehicle refrigerator by using available power from the battery to a first temperature from a second temperature, at a predefined time before the vehicle reaches the geographical area; and
cause the battery to provide a lower proportion of available power to the vehicle refrigerator and the higher proportion to the vehicle powertrain when the vehicle travels in the geographical area.

2. The vehicle of claim 1, wherein the processor is configured to determine the vehicle route based on vehicle historical travel patterns.

3. The vehicle of claim 1, further comprising a transceiver configured to obtain inputs from a vehicle operator.

4. The vehicle of claim 3, wherein the processor is configured to determine the vehicle route based on the inputs obtained from the vehicle operator.

5. The vehicle of claim 3, wherein the transceiver is further configured to obtain route information associated with the vehicle route, and wherein the route information comprises at least one of: a road slope information in the vehicle route, weather conditions in the vehicle route, or traffic information in the vehicle route.

6. The vehicle of claim 5, wherein the processor is configured to estimate the geographical area based on the route information.

7. The vehicle of claim 1, wherein the processor is further configured to:
obtain vehicle information that comprises real-time available power from the battery and a state of charge (SOC) level of the battery; and
control the vehicle refrigerator based on the vehicle information.

8. The vehicle of claim 7, wherein the processor is further configured to control a vehicle refrigerator compressor to control the vehicle refrigerator.

9. The vehicle of claim 8, wherein the processor is further configured to reduce a speed of the vehicle refrigerator compressor when the vehicle travels in the geographical area.

10. The vehicle of claim 1, wherein the processor is further configured to:
estimate an arrival time at which the vehicle is expected to reach the geographical area; and
commence precooling the vehicle refrigerator at the predefined time before the arrival time.

11. The vehicle of claim 1, wherein the geographical area comprises an uphill section.

12. The vehicle of claim 1, wherein the processor is further configured to:
determine that the vehicle is moving in a downhill section; and
increase cooling of the vehicle refrigerator responsive to a determination that the vehicle is moving in the downhill section.

13. The vehicle of claim 1, wherein the processor is further configured to:
predict a hot weather section in the vehicle route; and
precool the vehicle refrigerator based on the prediction of the hot weather section.

14. The vehicle of claim 1, wherein the processor is further configured to:
determine that the battery is in a charging state; and
precool the vehicle refrigerator responsive to a determination that the battery is in the charging state.

15. The vehicle of claim 1, wherein the processor is further configured to cause a vehicle speed to decrease before the vehicle reaches the geographical area to enable precooling of the vehicle refrigerator.

16. The vehicle of claim 1, further comprising a vehicle power system configured to transfer power from the battery to the vehicle refrigerator.

17. The vehicle of claim 1, wherein the processor is further configured to:
estimate the higher proportion of available power for the vehicle powertrain to enable the vehicle to travel in the geographical area, wherein the higher proportion of available power is greater than a predefined threshold value;
estimate the lower proportion of available power for the vehicle refrigerator based on the estimation of the higher proportion of available power, wherein the lower proportion of available power is a difference between the available power from the battery and the higher proportion of available power; and
cause the battery to provide the lower proportion of available power to the vehicle refrigerator and the higher proportion of available power to the vehicle powertrain when the vehicle travels in the geographical area.

18. A method comprising:
determining, by a processor, a vehicle route on a trip;
estimating, by the processor, a geographical area in the vehicle route in which a vehicle powertrain of a vehicle is expected to require a higher proportion of available power from a battery of the vehicle, wherein the battery is configured to power the vehicle powertrain and a vehicle refrigerator;
precooling, by the processor, the vehicle refrigerator by using available power from the battery to a first temperature from a second temperature, at a predefined time before the vehicle reaches the geographical area; and
causing, by the processor, the battery to provide a lower proportion of available power to the vehicle refrigerator and the higher proportion to the vehicle powertrain when the vehicle travels in the geographical area.

19. The method of claim 18 further comprising reducing a speed of a vehicle refrigerator compressor when the vehicle travels in the geographical area.

20. A non-transitory computer-readable storage medium having instructions stored thereupon which, when executed by a processor, cause the processor to:
determine a vehicle route on a trip;
estimate a geographical area in the vehicle route in which a vehicle powertrain of a vehicle is expected to require a higher proportion of available power from a battery of the vehicle, wherein the battery is configured to power the vehicle powertrain and a vehicle refrigerator;
precool the vehicle refrigerator by using available power from the battery to a first temperature from a second temperature, at a predefined time before the vehicle reaches the geographical area; and
cause the battery to provide a lower proportion of available power to the vehicle refrigerator and the higher proportion to the vehicle powertrain when the vehicle travels in the geographical area.
